(19) United States
(12) Patent Application Publication
(10) Pub. No.: US 2011/0021660 A1
(43) Pub. Date: Jan. 27, 2011

(54) FUNCTIONALIZED CARBON BLACK-FILLED RUBBERS

(75) Inventors: Norbert Steinhauser, Monheim (DE); Dave Hardy, Dormagen (DE); Thomas Gross, Wulfrath (DE)

Correspondence Address: LANXESS CORPORATION, 111 RIDC PARK WEST DRIVE, PITTSBURGH, PA, 15275-1112, US

(73) Assignee: LANXESS DEUTSCHLAND GMBH, Leverkusen (DE)

(21) Appl. No.: 12/676,609

(22) PCT Filed: Sep. 4, 2008
(86) PCT No.: PCT/EP08/61659

§ 371 Date: Jun. 22, 2010

(30) Foreign Application Priority Data
Sep. 15, 2007 (DE) 10 2007 044 174.8

(51) Int. Cl. C08J 5/14

(52) U.S. Cl. 523/150

(57) ABSTRACT

The invention relates to functionalized carbon black-filled rubbers, to the production of such rubber mixtures and to their use in producing vulcanized rubbers that are especially used for producing highly reinforced molded rubber products, especially for producing tires that have an especially low rolling resistance, especially good non-skid properties on wet surfaces and a good abrasion resistance.

The present invention relates to functionalized rubbers comprising carbon black, to the preparation of rubber mixtures of this type, and also to their use for the production of rubber vulcanizates. These are suitable mainly for the production of highly reinforced rubber mouldings, in particular for the production of tires, where these have particularly low rolling resistance, and particularly high wet skid resistance and abrasion resistance.

Anionically polymerized solution rubbers containing double bonds, e.g. solution polybutadiene and solution styrene-butadiene rubbers, have advantages over corresponding emulsion rubbers during production of low-rolling-resistance tire treads. The advantages lie inter alia in the controllability of vinyl content and the attendant glass transition temperature and the extent of molecular branching. Particular advantages result from this in practical applications in relation to wet skid resistance and rolling resistance of the tire. For example, U.S. Pat. No. 5,227,425 describes the production of tire treads from a solution styrene-butadiene rubber and silica. For further improvement of properties, numerous methods of end-group modification have been developed, as described in EP-A 334 042 using dimethylaminopropylacrylamide, and as described in EP-A 447,066 using silyl ethers, and using amine or a benzophenone derivative. However, by virtue of the high molecular weight of the rubbers, the proportion by weight of the end groups is low, and these can therefore have only little effect on the interaction between filler and rubber molecule. EP-A 1000971 discloses relatively highly functionalized copolymers containing carboxy groups and composed of vinylaromatics and diolefins, with a proportion of from 10 to 500 parts by weight of filler. The filler used there is primarily silica. In some instances, silica is used together with markedly lower proportions of carbon black. Silica has the advantage of permitting simple interaction of the OH groups of the silica surface with the carboxy groups of the functionalized rubber. Carbon black can therefore be used only as an additional constituent, because of its more strongly hydrophobic character, and provides colouring of the mixture.

However, a disadvantage of mixtures using silica is that they are more complicated to process, since the silica can be incorporated homogeneously into the rubber only with the aid of a silane. These silanes are moreover very expensive. Mixtures using carbon black as main filler component have the advantage of being less expensive, since the expensive silane can be omitted. They are easier to process, and this reduces mixing time and production costs.

An object was therefore to provide novel mixtures which are composed of functionalized rubbers and of fillers and are inexpensive and which can be prepared more easily, and which can be used to produce tires with improved wet skid resistance, lower rolling resistance, and high mechanical strength and improved abrasion performance.

Surprisingly, it has now been found that certain rubber mixtures comprising carbon black achieve this object with functionalized rubbers.

The present invention therefore provides rubber mixtures composed of at least one functionalized rubber and of from 10 to 500 parts by weight of carbon black, based on 100 parts by weight of rubber, where the rubber has been prepared via polymerization of diolefins and, if appropriate, of vinylaromatic monomers in solution and subsequent introduction of functional groups, this rubber has from 0.02 to 3% by weight, preferably from 0.05 to 2% by weight, of bonded functional groups and/or salts thereof, from 0 to 60% by weight, preferably from 15 to 45% by weight, content of copolymerized vinylaromatic monomers, and also from 40 to 100% by weight, preferably from 55 to 85% by weight, content of diolefins, where the content of 1,2-bonded diolefins (vinyl content) is from 0.5 to 95% by weight, preferably from 10 to 85% by weight, based in each case on the solution rubber used.

For the purposes of the invention, carbon blacks are carbon blacks prepared by the flame process, channel process, furnace process, gas process, thermal process, acetylene process or arc process, their BET surface areas being from 9 to 200 m²/g, e.g. super abrasion furnace (SAF), intermediate SAF (ISAF), intermediate SAF low structure (ISAF-LS), intermediate SAF high modulus (ISAF-HM), intermediate SAF low modulus (ISAF-LM), intermediate SAF high structure (ISAF-HS), conductive furnace (CF), super conductive furnace (SCF), high abrasion furnace (HAF), high abrasion furnace low structure (HAF-LS), HAF-HS, fine furnace high structure (FF-HS), semi reinforcing furnace (SRF), extra conductive furnace (XCF), fast extruding furnace (FEF), fast extruding furnace low structure (FEF-LS), fast extruding furnace high structure (FEF-HS), general purpose furnace (GPF), GPF-HS, all purpose furnace (APF), SRF-LS, SRF-LM, SRF-HS, SRF-HM and medium thermal (MT) carbon blacks, or the following types according to ASTM classification: N110, N219, N220, N231, N234, N242, N294, N326, N327, N330, N332, N339, N347, N351, N356, N358, N375, N472, N539, N550, N568, N650, N660, N754, N762, N765, N774, N787 and N990 carbon blacks.

The presence of further fillers, individually or in a mixture, is possible, but carbon black is always the main constituent, i.e. its amount present is at least 50%, based on the entire amount of filler. The other fillers can be either active or inactive fillers, such as:
fine-particle silicas, prepared, for example, via precipitation of solutions of silicates, or flame hydrolysis of silicon halides with specific surface areas of from 5 to 1000 m²/g, preferably from 20 to 400 m²/g (BET surface area) and with primary particle sizes of from 10 to 400 nm. The silicas can also, if appropriate, be present in the form of mixed oxides with other metal oxides, such as Al, Mg, Ca, Ba, Zn, Zr, or Ti oxides;
synthetic silicates, such as aluminium silicate, alkaline earth metal silicate, such as magnesium silicate or calcium silicate, with BET surface areas of from 20 to 400 m²/g and primary particle diameters of from 10 to 400 nm;
natural silicates, such as kaolin and other naturally occurring types of silica;
glass fibres and glass-fibre products (mats, strands) or glass microbeads;
metal oxides, such as zinc oxide, calcium oxide, magnesium oxide, or aluminium oxide;
metal carbonates, such as magnesium carbonate, calcium carbonate, or zinc carbonate;
metal hydroxides, such as aluminium hydroxide or magnesium hydroxide;
rubber gels, in particular polybutadiene-based rubber gels, butadiene-styrene copolymers, butadiene-acrylonitrile copolymers and polychloroprene.

In one preferred embodiment of the invention, the functionalized rubbers have one or more vinylaromatic monomers as constituent.

Examples of vinylaromatic monomers that may be mentioned and that can be used for the polymerization process are styrene, o-, m- and/or p-methylstyrene, p-tert-butylstyrene, methylstyrene, vinylnaphthalene, divinylbenzene, trivinylbenzene and/or divinylnaphthalene. Styrene is particularly preferably used.

Diolefins preferred are 1,3-butadiene, isoprene, 1,3-pentadiene, 2,3-dimethylbutadiene, 1-phenyl-1,3-butadiene and/or 1,3-hexadiene. Particular preference is given to use of 1,3-butadiene and/or isoprene.

The rubbers to be used according to the invention in the rubber mixtures and based on diolefins and, if appropriate, on vinylaromatic monomers, whose content of bonded functional groups is from 0.02 to 3% by weight, preferably have average (number-average) molar masses of from 50 000 to 2 000 000 g/mol, preferably from 100 000 to 1 000 000 g/mol, and glass transition temperatures of from −110° C. to +20° C., preferably from −50° C. to 0° C., and Mooney viscosities ML 1+4 (100° C.) of from 10 to 200, preferably from 30 to 150.

The inventive rubbers can bear, as functional groups and/or salts thereof, groups such as carboxy, hydroxy, amine, carboxylic ester, carboxamide or sulphonic acid groups. Carboxy or hydroxy groups are preferred. Preferred salts are alkali metal carboxylates, alkaline earth metal carboxylates, zinc carboxylates and ammonium carboxylates, and alkali metal sulphonates, alkaline earth metal sulphonates, zinc sulphonates and ammonium sulphonates.

The inventive rubbers here are preferably prepared via polymerization of diolefins and, if appropriate, of vinylaromatic monomers, in solution, and subsequent introduction of functional groups. By way of example, this can be achieved through anionic solution polymerization or through solution polymerization by means of coordination catalysts.

Coordination catalysts in this context are Ziegler-Natta catalysts or monometallic catalyst systems. Preferred coordination catalysts are those based on Ni, Co, Ti, Nd, V, Cr or Fe.

Anionic solution polymerization is preferred for the preparation of copolymers.

Anionic solution polymerization for the preparation of the rubbers preferably takes place by means of an initiator based on alkali metal, e.g. n-butyllithium, in an inert hydrocarbon as solvent.

The known randomizers and control agents for the microstructure of the polymer can also be used. Anionic solution polymerization processes of this type are known and are described by way of example in I. Franta Elastomers and Rubber Compounding Materials; Elsevier 1989, pages 73-74, 92-94, and in Houben-Weyl, Methoden der Organische Chemie [Methods of organic chemistry], Thieme Verlag, Stuttgart, 1987, Volume E 20, pages 114-134.

Solvents preferably used here are inert aprotic solvents, e.g. paraffinic hydrocarbons, such as isomeric pentanes, hexanes, heptanes, octanes, decanes, cyclopentane, cyclohexane, methylcyclohexane, ethylcyclohexane or 1,4-dimethylcyclohexane, or aromatic hydrocarbons, such as benzene, toluene, ethylbenzene, xylene, diethylbenzene or propylbenzene. These solvents can be used individually or in combination. Preference is given to cyclohexane and n-hexane. A blend with polar solvents is also possible.

The amount of solvent in the inventive process usually amounts to from 1000 to 100 g, preferably from 700 to 200 g, based on 100 g of the entire amount of monomer used. However, it is also possible to polymerize the monomers used in the absence of solvents.

The polymerization temperature can vary within a wide range and is generally in the range from 0° C. to 200° C., preferably from 40° C. to 130° C. The reaction time likewise varies widely from a few minutes to a few hours. The polymerization process is usually carried out within a period of from about 30 minutes to 8 hours, preferably from 1 to 4 hours. It can be carried out either at atmospheric pressure or else at an elevated pressure (from 1 to 10 bar).

The invention further provides a process for the preparation of the inventive rubber mixtures, in which diolefins and, if appropriate, vinylaromatic monomers are polymerized in solution to give rubber, and then the functional groups or salts thereof are introduced into the solution rubber, the solvent is removed with hot water and/or steam at temperatures of from 50 to 200° C., if appropriate under vacuum, and then carbon black and, if appropriate, process oil is added.

In another embodiment of the invention process, the diolefins and, if appropriate, vinylaromatic monomers are polymerized in solution to give rubber, and then the functional groups or salts thereof are introduced into the solution rubber, and then the solvent-containing rubber is mixed with process oil, and during or after the mixing procedure here the solvent is removed with hot water and/or steam at temperatures of from 50 to 200° C., if appropriate under vacuum, and then carbon black is added.

In other embodiments of the invention, the carbon black is added with the process oil after introduction of the functional groups.

In the inventive process, the polymerization of diolefins and, if appropriate, of vinylaromatic monomers takes place as described above, preferably in solution with subsequent introduction of functional groups.

Anionic solution polymerization is preferred here.

The functional groups here are introduced according to known processes, preferably in single- or multistage reactions, via addition reactions with corresponding functionalizing reagents to the double bonds of the rubber or via abstraction of allylic hydrogen atoms and subsequent reaction with functionalizing reagents.

The carboxy groups can be introduced in various ways into the rubber, an example being compounds such as CO₂ which provide carboxy groups are added to the metallated solution rubbers, or use of the transition-metal-catalysed hydrocarboxylation reaction known in the prior art, or treatment of the rubber with compounds containing carboxy groups, for example mercaptans containing carboxy groups.

Carboxy group content can be determined by known methods, e.g. titration of the free acid, spectroscopy or elemental analysis.

The introduction of the carboxy groups into the rubber preferably takes place after polymerization of the monomers used, in solution via reaction of the resultant polymers, if appropriate in the presence of free-radical initiators, with carboxymercaptans of the formula

HS—R¹—COOX or (HS—R¹COO)₂X

in which
R¹ is a linear, branched or cyclic C₁-C₃₆-alkylene group or C₁-C₃₆-alkenylene group, each of which, if appropriate, can have up to three further carboxy groups as substituents, or can have interruption by nitrogen atoms, by oxygen atoms or by sulphur atoms, or is an aryl group, and
X is hydrogen or a metal ion, e.g. Li, Na, K, Mg, Zn, Ca or an ammonium ion which, if appropriate, has C₁-C₃₆-alkyl groups, C₁-C₃₆-alkenyl groups, cycloalkyl groups or aryl groups as substituents.

Preferred carboxymercaptans are thioglycolic acid, 2-mercaptopropionic acid (thiolactic acid), 3-mercaptopropionic acid, 4-mercaptobutyric acid, mercaptohexanoic acid, mercaptooctanoic acid, mercaptodecanoic acid, mercaptoundecanoic acid, mercaptododecanoic acid, mercaptooctadecanoic acid, 2-mercaptosuccinic acid, and the alkali metal and alkaline earth metal, zinc or ammonium salts thereof. It is particularly preferable to use 2- and 3-mercaptopropionic acid, mercaptobutyric acid and 2-mercaptosuccinic acid, and the lithium, sodium, potassium, magnesium, calcium, zinc or ammonium salts thereof. Particular preference is given to 3-mercaptopropionic acid, and the lithium, sodium, potassium, magnesium, calcium, zinc or ammonium, ethylammonium, diethylammonium, triethylammonium, stearylammonium and cyclohexylammonium salts thereof.

The reaction of the carboxymercaptans with the solution rubbers is generally carried out in a solvent, for example hydrocarbons, such as pentane, hexane, cyclohexane, benzene and/or toluene, at temperatures of from 40 to 150° C., in the presence of free-radical initiators, e.g. peroxides, in particular acyl peroxides, such as dilauroyl peroxide and dibenzoyl peroxide, and ketal peroxides, such as 1,1-bis(tert-butylperoxy)-3,3,5-trimethylcyclohexane, or else azo initiators, such as azobisisobutyronitrile, or of benzopinacol silyl ethers, or in the presence of photoinitiators and visible or UV light.

The amount of carboxymercaptans to be used depends on the desired content of bonded carboxy groups or salts thereof in the solution rubber to be used in the rubber mixtures.

The carboxylic salts can also be prepared after the introduction of the carboxylic acid groups into the rubber, via neutralization thereof.

The hydroxy groups can, for example, be introduced into the rubber by epoxidizing the solution rubber and then ring-opening the epoxy groups, hydroborating the solution rubber and then treating it with alkaline hydrogen peroxide solution, or treating the rubber with compounds containing hydroxy groups, for example mercaptans containing hydroxy groups.

The introduction of the hydroxy groups into the rubber preferably takes place after polymerization of the monomers used, in solution via reaction of the resultant polymers, if appropriate in the presence of free-radical initiators, with hydroxymercaptans of the formula

HS—R²—OH

in which
R² is a linear, branched or cyclic C₁-C₃₆-alkylene group or C₁-C₃₆-alkenylene group, each of which, if appropriate, can have up to three further hydroxy groups as substituents, or can have interruption by nitrogen atoms, by oxygen atoms or by sulphur atoms, or is an aryl group.

Preferred hydroxymercaptans are thioethanol, 2-mercaptopropanol, 3-mercaptopropanol, 4-mercaptobutanol, 6-mercaptohexanol, mercaptooctanol, mercaptodecanol, mercaptododecanol, mercaptohexadecanol, mercaptooctadecanol. Particular preference is given to mercaptoethanol, 2- and 3-mercaptopropanol and mercaptobutanol.

The reaction of the hydroxymercaptans with the solution rubbers is generally carried out in a solvent, the method for this being the same as described for the carboxymercaptans.

Carboxylic ester groups and amino groups can be introduced in corresponding fashion from mercaptocarboxylic esters and mercaptoamines of the general formula

HS—R³—COOR⁴, HS—R³—NR⁵R⁶

in which
R³ is a linear, branched or cyclic C₁-C₃₆-alkylene group or C₁-C₃₆-alkenylene group, each of which, if appropriate, can have up to three further carboxylic ester groups or amino groups as substituents, or can have interruption by nitrogen atoms, by oxygen atoms or by sulphur atoms, or is an aryl group, and
R⁴ is a linear, branched or cyclic C₁-C₃₆-alkyl group or C₁-C₃₆-alkenyl group which, if appropriate, can have interruption by nitrogen atoms, by oxygen atoms or by sulphur atoms, or is a phenyl group which can have up to five alkyl substituents or aromatic substituents,
R⁵ and R⁶ are hydrogen or a linear, branched or cyclic C₁-C₃₆-alkyl group C₁-C₃₆-alkenyl group which, if appropriate, can have interruption by nitrogen atoms, by oxygen atoms or by sulphur atoms, or is a phenyl group which can have up to five alkyl substituents or aromatic substituents.

The resultant functionalized rubbers are then blended with process oil and carbon black and with the other mixture constituents, in or on suitable mixing apparatus, such as kneaders, mills or extruders.

Additional rubbers can be admixed with the inventive rubber mixtures, alongside the functionalized rubber. The amount of the additional rubbers is usually in the range from 0.5 to 85% by weight, preferably from 10 to 70% by weight, based on the total amount of rubber in the rubber mixture. The amount of additionally added rubbers in turn depends on the respective intended use of the inventive rubber mixtures.

Examples of additional rubbers are natural rubber and synthetic rubber. These are then admixed after the functionalization process.

Synthetic rubbers known from the literature are listed here by way of example. They encompass inter alia
BR=polybutadiene
ABR=butadiene/C₁-C₄-alkyl acrylate copolymers
CR=polychloroprene
IR=polyisoprene
SBR=styrene-butadiene copolymers with styrene contents of from 1 to 60% by weight, preferably from 20 to 50% by weight
IIR=isobutylene-isoprene copolymers
NBR=butadiene-acrylonitrile copolymers with acrylonitrile contents of from 5 to 60% by weight, preferably from 10 to 40% by weight
HNBR=partially hydrogenated or completely hydrogenated NBR rubber
EPDM=ethylene-propylene-diene terpolymers
   and mixtures of these rubbers. For the production of motor vehicle tires, materials of particular interest are natural rubber, emulsion SBR and solution SBR whose glass transition temperature is above −50° C., polybutadiene rubber with high cis content (>90%) which has been prepared using catalysts based on Ni, Co, Ti or Nd, and polybutadiene rubber with vinyl content of up to 80%, and mixtures thereof.

The inventive rubber mixtures can, of course, also comprise other rubber auxiliaries, which by way of example serve for the crosslinking of the rubber mixtures, or which improve the physical properties of the vulcanizates produced from the inventive rubber mixtures, for the intended specific application thereof.

Particular crosslinking agents used are sulphur or sulphur-donor compounds. The inventive rubber mixtures can moreover, as mentioned, comprise other auxiliaries, such as the known reaction accelerators, antioxidants, heat stabilizers, light stabilizers, antiozonants, processing aids, plasticizers, tackifiers, blowing agents, dyes, pigments, waxes, extenders, organic acids, retarders, metal oxides and activators.

The amounts used of the inventive rubber auxiliaries are those which are known and conventional, and the amount used here depends on the intended subsequent use of the rubber mixtures. By way of example, usual amounts of rubber auxiliaries are in the range from 2 to 70 parts by weight, based on 100 parts by weight of rubber.

The present invention further provides the use of the inventive rubber mixtures for the production of vulcanizates, which in turn serve for the production of highly reinforced rubber mouldings, in particular for the production of tires.

The examples below serve to illustrate the invention, but without any limiting effect.

### EXAMPLES

Table 1 below describes the properties of the styrene-butadiene rubbers used for the rubber mixtures of the examples. The styrene-butadiene rubber SBR 1 was prepared via anionic copolymerization of butadiene and styrene in solution and, after the polymerization process in solution, functionalized via reaction with 3-mercaptopropionic acid in the presence of 1,1-di(tert-butylperoxy)-3,3,5-trimethylcyclohexane as free-radical generator. The rubbers used in Examples 2-7 (SBR 2-7) are commercially available products from Lanxess Deutschland GmbH, with the constituents listed below.

Prior to removal of the solvent by steam, process oil (DAE oil (distillate aromatic extract) or TDAE oil (treated distillate aromatic extract)) was mixed with the rubbers SBR 1 and SBR 3-7.

TABLE 1

| | Inventive | Comparative | Comparative | Comparative | Comparative | Comparative | Comparative |
|---|---|---|---|---|---|---|---|
| | example | example 1 | example 2 | example 3 | example 4 | example 5 | example 6 |
| | SBR 1 | SBR 2 | SBR 3 | SBR 4 | SBR 5 | SBR 6 | SBR 7 |
| Functionalization [% | 0.16 | — | — | — | — | — | — |
| by wt. of COOH] | | | | | | | |
| Mooney viscosity | 69 | 65 | 50 | 47 | 62 | 50 | 50 |
| (ML 1 + 4 at 100° C.) | | | | | | | |
| Vinyl content [% by | 41 | 50 | 50 | 50 | 50 | 55 | 52 |
| wt., based on SBR] | | | | | | | |
| Styrene content [% | 24 | 25 | 25 | 25 | 25 | 25 | 28 |
| by wt., based on | | | | | | | |
| SBR] | | | | | | | |
| Oil content [% by | 27 | — | 27 | 27 | 27 | 27 | 27 |
| wt.] | (TDAE) | | (DAE) | (TDAE) | (TDAE) | (DAE) | (TDAE) |
| Tg (DSC) [° C.] | −29 | −22 | −25 | −29 | −29 | −20 | −20 |

SBR 2: Buna ® VSL 5025-0 HM, having vinyl content of 50% and styrene content of 25%,
SBR 3: Buna ® VSL 5025-1 having vinyl content of 50%, styrene content of 25%, and oil content (DAE) of 37.5 phr,
SBR 4: Buna ® VSL 5025-2 having vinyl content of 50%, styrene content of 25%, and oil content (TDAE) of 37.5 phr,
SBR 5: Buna ® VSL 5025-2 HM having vinyl content of 50%, styrene content of 25%, and oil content (TDAE) of 37.5 Phr,
SBR 6: Buna ® VSL 5525-1 having vinyl content of 55%, styrene content of 25%, and oil content (DAE) of 37.5 phr,
SBR 7: Buna ® VSL KA 8975 having vinyl content of 52%, styrene content of 28%, and oil content (TDAE) of 37.5 phr, where 1 phr corresponds to 1 g of substance, based on 100 g of polymer.
Rubber mixtures which comprise the styrene-butadiene rubbers SBR 1-7 and other mixture constituents according to Table 2 were prepared in a 1.5 L kneader (without sulphur and accelerator). The mixture constituents sulphur and accelerator were then admixed on a mill at 40° C.

TABLE 2
Mixture constituents (data in phr)

| | Constitution | | | | | | |
|---|---|---|---|---|---|---|---|
| | Inventive | Comparative | Comparative | Comparative | Comparative | Comparative | Comparative |
| | example | example 1 | example 2 | example 3 | example 4 | example 5 | example 6 |
| SBR 1 | 89.38 | 0 | 0 | 0 | 0 | 0 | 0 |
| (inventive) | | | | | | | |
| SBR 2 | 0 | 65 | 0 | 0 | 0 | 0 | 0 |
| (comparative | | | | | | | |
| example) | | | | | | | |
| SBR 3 | 0 | 0 | 89.38 | 0 | 0 | 0 | 0 |
| (comparative | | | | | | | |
| example) | | | | | | | |
| SBR 4 | 0 | 0 | 0 | 89.38 | 0 | 0 | 0 |
| (comparative | | | | | | | |
| example) | | | | | | | |
| SBR 5 | 0 | 0 | 0 | 0 | 89.38 | 0 | 0 |
| (comparative | | | | | | | |
| example) | | | | | | | |
| SBR 6 | 0 | 0 | 0 | 0 | 0 | 89.38 | 0 |
| (comparative | | | | | | | |
| example) | | | | | | | |
| SBR 7 | 0 | 0 | 0 | 0 | 0 | 0 | 89.38 |
| (comparative | | | | | | | |
| example) | | | | | | | |
| Buna CB 24 | 35 | 35 | 35 | 35 | 35 | 35 | 35 |
| polybutadiene | | | | | | | |
| rubber | | | | | | | |
| Corax N 234 | 75 | 75 | 75 | 75 | 75 | 75 | 75 |
| carbon black | | | | | | | |
| DAE oil | 0 | 0 | 13.12 | 0 | 0 | 13.12 | 0 |
| (Tudalen 65) | | | | | | | |
| TDAE oil | 13.12 | 37.5 | 0 | 13.12 | 13.12 | 0 | 13.12 |
| (Vivatec | | | | | | | |
| 500) | | | | | | | |
| Stearic acid | 2 | 2 | 2 | 2 | 2 | 2 | 2 |
| (Edenor C 18 | | | | | | | |
| 98-100) | | | | | | | |
| Stabilizer | 1.5 | 1.5 | 1.5 | 1.5 | 1.5 | 1.5 | 1.5 |
| TMQ | | | | | | | |
| (Vulkanox ® | | | | | | | |
| HS) | | | | | | | |
| Paraffin wax | 2.5 | 2.5 | 2.5 | 2.5 | 2.5 | 2.5 | 2.5 |
| (Antilux 654) | | | | | | | |
| ZnO | 4 | 4 | 4 | 4 | 4 | 4 | 4 |
| Sulphenamide | 1.2 | 1.2 | 1.2 | 1.2 | 1.2 | 1.2 | 1.2 |
| accelerator | | | | | | | |
| (Vulkacit ® | | | | | | | |
| CZ) | | | | | | | |
| Sulphur | 1.75 | 1.75 | 1.75 | 1.75 | 1.75 | 1.75 | 1.75 |

The mixtures were vulcanized at 160° C. for 20 minutes.

TABLE 3
Vulcanizate properties

| | Inventive | Comparative | Comparative | Comparative | Comparative | Comparative | Comparative |
|---|---|---|---|---|---|---|---|
| | example | example 1 | example 2 | example 3 | example 4 | example 5 | example 6 |
| Rebound resilience at | 31.5 | 26 | 23 | 27 | 27 | 22 | 23 |
| 23° C. [%] | | | | | | | |
| Rebound resilience at | 46.6 | 37.5 | 35.6 | 41.2 | 40.5 | 35.8 | 37.7 |
| 60° C. [%] | | | | | | | |
| tan δ at 0° C. (dynamic | 0.274 | 0.217 | 0.248 | 0.252 | 0.221 | 0.269 | 0.267 |
| damping at 10 Hz) | | | | | | | |
| tan δ at 60° C. | 0.143 | 0.156 | 0.176 | 0.148 | 0.160 | 0.159 | 0.157 |
| (dynamic damping at | | | | | | | |
| 10 Hz) | | | | | | | |
| Heat build-up | 25.8 | 47.7 | 38.5 | 34.2 | 33.8 | 32.3 | 38.1 |
| (Goodrich | | | | | | | |
| Flexometer) [° C.] | | | | | | | |
| Residual deformation | 8.4 | 22.0 | 15.9 | 13.6 | 13.2 | 13.2 | 14.4 |
| (Goodrich Flexom.) | | | | | | | |
| Abrasion (DIN | 75 | 77 | 85 | 84 | 77 | 95 | 90 |
| 53516) [mm³] | | | | | | | |

Tire applications require a low rolling resistance, and this is present if, in the vulcanizate, the value measured for rebound resilience at 60° C. is high, and the tan δ value measured for dynamic damping at 60° C. is low, and the heat build-up value measured is low. As can be seen from Table 3, the vulcanizate of the inventive example features the highest rebound resilience at 60° C., the lowest tan δ value for dynamic damping at 60° C., and the lowest heat build-up value.

Tire applications moreover require high wet skid resistance. This is present if, in the vulcanizate, the tan δ value measured for dynamic damping at 0° C. is high. As can be seen from Table 3, the vulcanizate of the inventive example features the highest tan δ value for dynamic damping at 0° C.

High abrasion resistance is likewise essential for tire applications. As can be seen from Table 3, the vulcanizate of the inventive example features the lowest abrasion.

The inventive mixture moreover exhibits the best values in relation to tensile strength and also has low residual deformation.

1-8. (canceled)

9. A rubber mixture comprising:
at least one rubber having bonded thereto one or more functional groups and/or their salts, wherein said functional groups and/or their salts are present in an amount of from 0.02 to 3% by weight based on the rubber; and
from 10 to 500 parts by weight of carbon black, based on 100 parts by weight of the rubber,
wherein the rubber comprises a polymerization product of at least one diolefin, and
wherein said at least one diolefin is present in an amount of from 40 to 100% by weight based on the rubber and comprises 1,2-addition product in the amount of from 0.5 to 95% by weight based on the rubber.

10. The rubber mixture according to claim 9, wherein the functional groups are selected from the group of carboxy, hydroxyl, and mixtures thereof.

11. The rubber mixture according to claim 9, wherein the polymerization product further comprises at least one vinylaromatic monomer present in an amount of less than or equal to 60% by weight based on the rubber.

12. The rubber mixture according to claim 11, wherein the vinylaromatic monomer is styrene.

13. The rubber mixture according to claim 9, wherein the diolefin is selected from the group consisting of 1,3-butadiene, isoprene, and mixtures thereof.

14. The rubber mixture according to claim 9, further comprising:
a filler, and
wherein said carbon black is present in an amount of at least 50%, based on the total amount of filler.

15. A process for the preparation of the rubber mixture according to claim 9, comprising:
polymerizing the diolefin in solution thereby forming a rubber solution; and
subsequently introducing functional groups and/or their salts into the rubber solution, and thereafter removing the rubber solution solvent with hot water and/or steam at temperatures of from 50 to 200° C., thereby forming a functionalized rubber; and
thereafter adding to the functionalized rubber, the carbon black, thereby forming said rubber mixture.

16. The process according to claim 15, further comprising:
polymerizing a vinylaromatic monomer in combination with said polymerizing of the diolefin.

17. A process for the production of a highly reinforced rubber molding, comprising:
forming the rubber mixture according to claim 9 into the highly reinforced rubber molding.

18. A process for the production of tires, comprising:
forming a tire from a plurality of materials, said materials comprising said rubber mixture according to claim 9.
